(19) United States
(12) Patent Application Publication
(10) Pub. No.: US 2007/0122786 A1
(43) Pub. Date: May 31, 2007

(54) Video karaoke system

(75) Inventors: Sandeep Kumar Relan, Bangalore (IN); Brajabandhu Mishra, Orissa (IN); Rajendra Kumar Khare, Bangalore (IN)

Correspondence Address: SQUIRE, SANDERS & DEMPSEY L.L.P., 14TH FLOOR, 8000 TOWERS CRESCENT, TYSONS CORNER, VA, 22182, US

(73) Assignee: BROADCOM CORPORATION

(21) Appl. No.: 11/288,346

(22) Filed: Nov. 29, 2005

(51) Int. Cl. G09B 5/00

(52) U.S. Cl. 434/308

(57) ABSTRACT

A video karaoke system comprises a first video source and a second video source, providing input to a mixing unit. The mixing unit provides a composite output that includes at least a portion of the video data from the first video source and a portion of video data from the second video source. The output of the mixing unit is configured to display on a display unit. The present invention also provides a method of mixing video data from plurality of video sources providing a combined output. The method comprises providing a plurality of video sources, and a region selecting unit selecting regions of interest from the plurality of video sources. The selected regions of interest from the plurality of video sources are then mixed to provide a combined output video image.

### BACKGROUND OF THE INVENTION

1. Field of the Invention

The present invention relates generally to real time creation and display of combined video sources by a composite video system, also referred to as a video karaoke system.

2. Description of the Related Art

Audio karaoke has been used by individuals to create music during a live performance wherein a user reviews hints or cues provided and responds to the hints by singing at the appropriate times. The hints are typically scrolling lyrics or background instrumental and vocal music, or both.

However, the features of audio karaoke have not been applied to a video environment. A technology called picture-in-picture is supported by some expensive televisions. These only allow an additional window to open up in predetermined section of a television where a second channel may be viewed.

Currently, composite video systems do not exist that incorporate information from multiple video streams and combine them realistically in real time. Similarly, tele-presence systems are primitive and do not support combining subsets of information from multiple video sources.

Current technology, for example, relating to interviewing two individuals in two separate places, is based on having a split screen or multiple boxes within a screen to show the two individuals talking, but who are clearly located in separate places. Video editing provides a way to painstakingly and manually combine the video sources to create an illusion of multiple video sources being a single video source. However, there does not currently exist a real time system, which enables multiple video sources to be combined in such a way so as to create an illusion of a single video source.

Additionally, there is no existing video system comparable to audio karaoke, which enable a live performance to react to cues in a recorded visual performance to insert dynamic video into the recorded video or visual performance.

Thus, a need exists for improvements in the manner with which the video sources and the video systems are made compatible in environments such as a homes or places of entertainment.

Further limitations and disadvantages of conventional and traditional approaches will become apparent to one of ordinary skill in the art through comparison of such systems with the present invention.

### BRIEF DESCRIPTION OF THE DRAWINGS

FIG. 1 is a functional block diagram illustrating the operation of a video karaoke system 105 built in accordance with an embodiment of the present invention.

FIG. 2 is a flow chart showing exemplary operation of video karaoke system;

FIG. 3 is a schematic block diagram illustrating an embodiment of a video karaoke system in accordance with an embodiment of the present invention;

FIG. 4 is a schematic block diagram of a video karaoke system in accordance with another invention, wherein a video art library is used in addition to a first video source and a second video source, to create combined video outputs;

FIG. 5 is a perspective block diagram of an exemplary region selecting unit that comprises a image tracking unit that is capable of tracking, and is configured to track, a dynamic image from a input video source;

FIG. 6 is a schematic block diagram illustrating use of video karaoke system for assembling and transmitting a composite video signal, such as those used created by combining video data from one or more video sources, prior to a video broadcast of the combined video data for a satellite broadcast or cable TV broadcast; and

FIG. 7 is schematic block diagram of video karaoke system for combining information from different video sources to get a multi-spectral information about the scene.

### DETAILED DESCRIPTION OF THE PREFERRED EMBODIMENTS

The present invention relates generally to real time creation and display of combined video sources by a composite video system. Although the following discusses aspects of the invention in terms of a video karaoke system, it should be clear that the following also applies to other systems such as, for example, live video broadcast, virtual reality systems, etc.

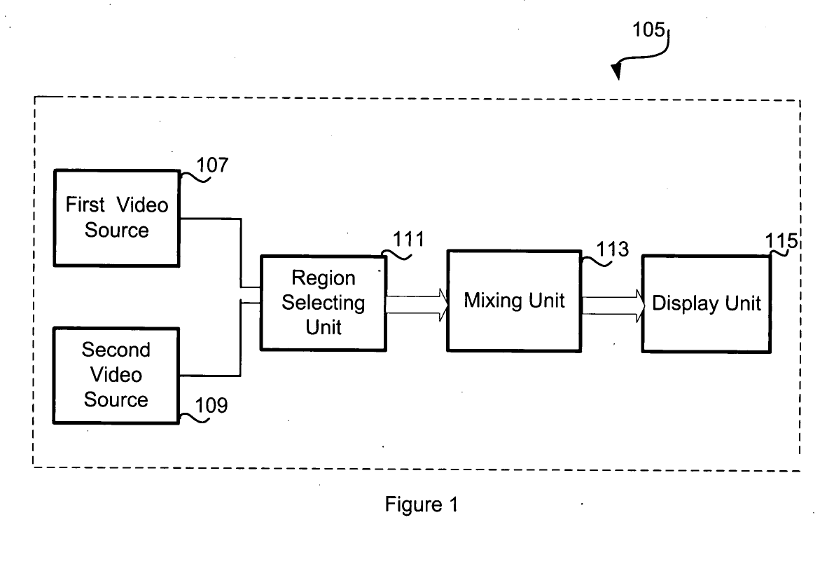

The video karaoke system 105, shown in FIG. 1, is used in a variety of ways, including the manipulations and composition of photograph inside a video paint system, and texture mapping onto 3D graphical models to achieve realism. It can also be used for dynamic virtual reality, sometimes called tele-presence, which combines video from multiple sources in real time to create the illusion of being in a dynamic and reactive 3D environment. Another example might be to view a 3D version of a concert or sporting event with the control dynamic exercised over the camera shots, even seeing the event from a player's point of view. Other examples might be to participate or consult in an activity such as surgery from a remote location (telemedicine) or to participate remotely in a virtual classroom. Building such a dynamic 3D model at acceptable frame rates is not currently available.

Another example might be viewing a prerecorded action scene on a display, wherein the viewer physically enacts portions of the scene in front of a video capture device such as a camera. The feed of the camera is then superimposed on the action scene, to create an illusion that the viewer is part of the action scene. The viewer can therefore take hints or cues from the combined scene viewed on the display.

FIG. 1 is a functional block diagram illustrating the operation of a video karaoke system 105 built in accordance with the present invention. The video karaoke system 105 facilitates the creation of composite video from a plurality of video sources. The video karaoke system 105 comprises a first video source 107, a second video source 109, a region selecting unit 111, mixing unit 113 and a display unit 115. The mixing unit 113 is used for mixing video information from multiple video sources such as the first video source 107 and the second video source 109. The region selecting unit 111 is communicatively coupled to the mixing unit 113 and provides one or more regions of video data from the multiple video sources such as the first video source 107 and the second video source 109. The output of mixing unit is displayed on the display unit 115. The region selecting unit 111 is capable of selecting one or more regions of interest from a video source and making it available for mixing by a mixing unit 113.

In one embodiment, the first video source 107 is a pre-recorded video program and the second video source 109 is a live video data, or audio-visual data, captured from a camera. In addition, the second video source captures a viewers actions that are combined by the mixing unit 113 with a pre-recorded video unit, the combined output being displayed by the display unit 115 such that the viewer can see the display and react to it.

In another embodiment, the mixing unit 113 mixes the information from different video sources by changing certain parameters of the video sources. For example, the first video source 105 can be a static data of a background scene, while the second video source 107 can be an image of a person. The video data from the second video source 109 is view morphed and mixed with the video data from the first video source 107 and the combined output is displayed on the display unit 115. This mixing also comprises mixing of video, graphics and text by adjusting certain parameters of the video sources 107, 109.

In a different embodiment, the region selecting unit 111 or the mixing unit 113 might be configured with a resolution-adjusting capability, such that in situations where first video source 107 and second video source 109 are in different spectral bands or have different resolutions, the resolutions can be adjusted as necessary. For example, in some implementations it might be desirable to adjust the resolution of the background scene so that an illusion of a 3D image can be created. Various phase shifting implementations can also be utilized, or a conventional 3D video data employing well known 3D-glasses could be implemented.

In one embodiment, the invention includes a composite video system having a first video source 107 and a second video source 109 wherein the video karaoke system 105 combines at least a portion of a video data from each video source to create a composite video. The mixing unit 113 receives first and second video data from the first and second video sources 107, 109, with the mixing unit 113 providing a combined output having at least a portion of the first video from the first video source 107 and a second video data from the second video source 109 in a composite video stream.

In another embodiment, the invention includes a video karaoke system 105 having plurality of video sources, each providing a different type of video data. For example, one of them provides a still video image, another provides a live video image such as those captured by a digital camera, while a third provides a pre-recorded video clip. A mixing unit 113 receives video data from the plurality of video sources, with the mixing unit 113 providing a combined output having at least portion of plurality of video data in a combined output video stream that is stored (such as in a personal video storage) or optionally displayed.

The present invention also provides a method of providing a combined output video image from one or more input video sources. The method comprises providing a first 107 and second video source 109 and selecting a region of interest in the first or second video source. The method also comprises mixing the selected region of interests from the first 107 and second video source 109 to provide a combined output video image that may be stored or displayed on a display unit 115, or both.

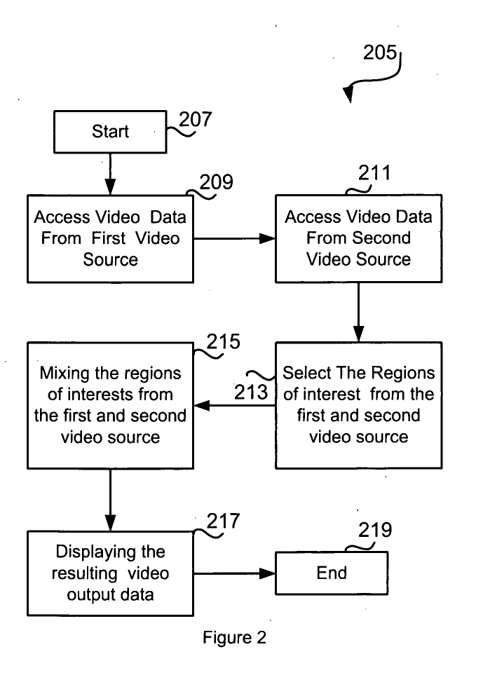

FIG. 2 is a flow chart showing exemplary operation 205 of video karaoke system. The operation starts at a start block 207 when the user activates the system and provides a plurality of video inputs. Then at the next block 209, the video karaoke system accesses the video data from the first video source. This occurs when the user designates the source, such as a pre-recorded video from a DVD player, etc. Then, at a next block 211, the video karaoke system accesses the video data from the second video source. Then, at a next block 213, the regions of interest from the first and second video sources are selected. For example, the video karaoke system facilitates receiving the video data from the plurality of video sources and selecting user defined regions of interest from the first and second video sources.

Then, at a next block 215, the mixing unit mixes the required regions of interest from the first and second video sources to create a combined output that can be displayed. At the next block 217, the combined output from the mixing unit is displayed on the display unit. Finally, the operation terminates at an end block 219.

In one embodiment of the present invention, the display unit displays an overlay of two unrelated video streams that is combined together by a mixing unit that superimposes the region of interests from the first video source onto the region of interest of second video source.

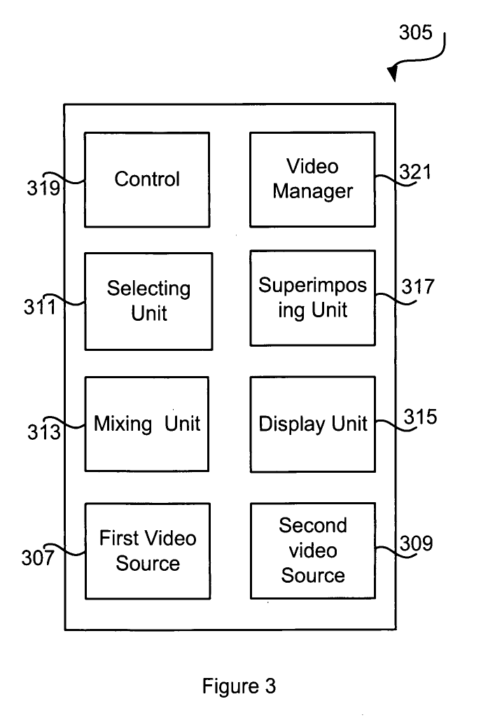

FIG. 3 is a schematic block diagram illustrating an embodiment of a video karaoke system 305 in accordance with the present invention. The video karaoke system 305 comprises a first video source 307, a second video source 309, a selecting unit 311, a control unit 319, a video manager 321 and a superimposing unit 317. The selecting unit is communicatively coupled to, for example, the mixing unit 313, the output of which is connected to a display 315. The selecting unit 311 is configured to select a region of interest from the first video source 307 and the second video source 309, based upon input from a user, via the control, or a configuration that has been previously set.

A user can select the regions of interest from the video sources 307, 309 while the associated video data is being fed to the selecting unit 311. In one embodiment, utilizing such conventional input and control devices such as the keyboard, mouse, wireless pointing device, a tablet, a touch-screen, etc. the user can control the selecting unit 311.

The appropriate regions of interest in the input video sources 307, 30 are selected based upon appropriate locating methods, such as coordinates in an area of a screen. In addition, selection of a predefined object is supported, whether it is selection dynamic or a static selection based upon predefined characteristics of the object.

In general, software or hardware can be configured within the selecting unit 311 to track or to follow a dynamic region of interest, such as a talking person, a moving person or object such as a condenser, a racing car, or virtually any other moving device. The mixing unit 313 can be configured to superimpose video information from the first video source 307 onto a background from second video source 309, or to superimpose information from second video source 309 onto an image provided by first video source 307.

In one embodiment, a separate superimposing unit 317 is used to superimpose one image from one video source onto another. One example of such superimposition might be the utilization of background information, such as a mountain scene or a stage, from second video source 309 for superimposing the image of a person onto the selected background, the image of the person being accessed from the first video source, which could be based upon a video created in a studio. Through the use of image tracking software provided in either the selecting unit 311 or the mixing unit 313, a moving image can be tracked from the first video source 307, and realistically superimposed onto the background scene extracted from the second video source 309. In one embodiment, the software and hardware provided with the video karaoke system 305 is used to adjust shading and contrast between the superimposed images so as to provide a realistic superimposition of the superimposed image onto the background scene. In a related embodiment, the video manager 321 facilitates such adjustments of shading and contrasts, utilizing the control 319.

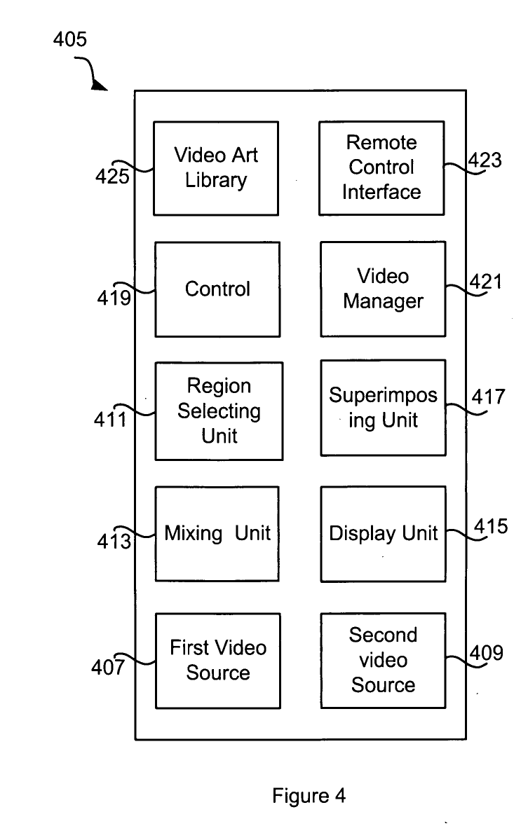

FIG. 4 is a schematic block diagram of a video karaoke system 405 in accordance with another invention, wherein a video art library 425 is used in addition to a first video source and a second video source 409, to create combined video outputs. The video karaoke system 405 includes the first video source 407, the second video source 409, which are selectively used as inputs to a region selecting unit 411. The region selecting unit 411 is connected to a mixing unit 413, and the output of which is connected to a display unit 115. The region selecting unit 111 is configured to select a user defined region of interest form the video sources, such as the first video source 407 and the second video source 409, while video is being fed to the region selecting unit 411. Utilizing such conventional input and control devices such as a keyboard, a mouse, a wireless pointing device, a tablet, a touch-screen, etc., a user controls the region selecting unit 411. In particular, the keyboard or the mouse can be plugged into the control 419 that facilitates selection of regions of interest in the various video sources. A touch-screen interface is also provided by the control 419. A remote control interface 423 provides access to various features of the video karaoke system 405 via a wireless pointing device, a tablet, etc.

The appropriate regions of interest are selected based upon locating methods such as identifying coordinates in an area of a screen, selection of a predefined object from a list of predefined objects, dynamic determination of objects based upon predefined characteristics of objects, etc. Software or hardware can be configured within the region selecting unit 111 to track or to follow a dynamic region of interest, such as a talking person, a moving person or object such as a condenser, a racing car, or virtually any other moving device.

The video karaoke system 405 also comprises the remote control interface 423, and the video manager 421, which together facilitate the remote control of the region of interest from the video sources. In addition, superimposition of video images from the various sources is also supported.

One example of video superimposition is superimposition of thermal IR data on visual data for detecting seepage in the walls. The first video source 407 could be stored visual data from video art library 425, the second video source 409, could be thermal IR data of the same scene. The region selecting unit 411, coupled to both the first video source 407 and second video source 409, is used to select a user defined region of interest from the video sources 407, 409. The required region of interest from second video source 409, for example, is superimposed on the video from the first video source 407, so that seepage in the walls can be detected, since it is not possible using visual band data to detect the seepage in the walls.

In certain embodiments of the invention, the display 115 is placed in visual proximity to a viewer who is presumed to be participating in a event wherein the user's image is incorporated into a displayed video content or program. The viewer is therefore performing in front of a camera that serves as the first or second video source 407, 409. Watching the combined output on the display unit 415, which could be a background scene from one video source with a superimposed image of the viewer captured in real-time using a camera, the viewer can adapt his or her physical movement so as to make the physical movements synchronize with movements of an object in the other video source with which it is being combined. Thus, using the mixing unit 413, and video inputs from two sources, wherein one of them is a live video captured from a viewer acting such that his physical movements are made in a reaction to another video source that is viewed, a realistic video karaoke image is created that is displayed on the display unit 415.

In one embodiment, a motion picture scene, a video program, a video game, or other scene from one of the video sources is combined with video data from the video library 425 or video data from the other video source. It should be noted that the elements illustrated in FIG. 4 can, in other related embodiments, be implemented as separate elements, or could be combined into the region selecting unit 411 or the mixing unit 413. In one embodiment, the selecting unit 411 and the mixing unit 413 are combined into a single unit.

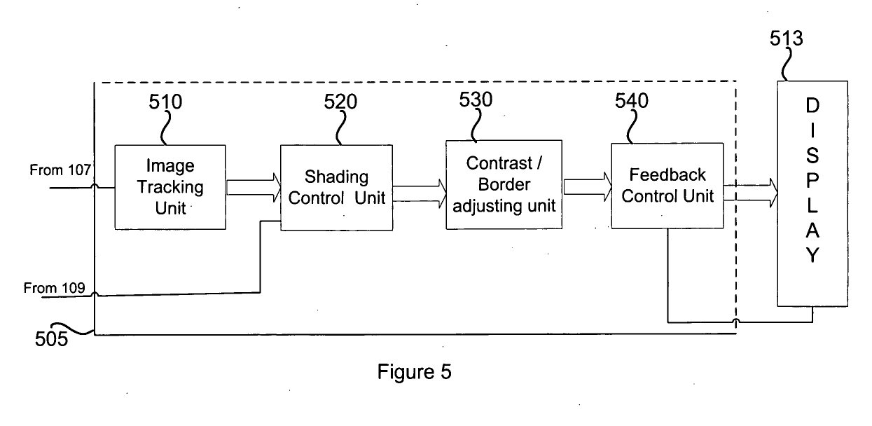

FIG. 5 is a perspective block diagram of an exemplary region selecting unit 505 that comprises a image tracking unit 510 that is capable of tracking, and is configured to track, a dynamic image from a input video source. The region selecting unit 505 also comprises a to shading control unit 520, a contrast/border adjusting unit 530 and a feedback unit 540. The tracking unit 510, for example, can be used to track a talking person, a moving vehicle, a dancer, etc., that may move around on the screen. The tracking unit 510 receives the signal from first video source 107. The tracked image, or the image data from the first video source 107, can be provided to the shading control unit 520, which also receives input from a second video source 109. The shading control unit 520 can be configured to adjust the shading of the image from first video source 107 so that it is consistent with shading based upon light sources from second video source 109. The contrast/border adjusting unit 530 is provided and configured to adjust or “soften” the border between the superimposed image and the background, to provide added realism to the combined image. This contrast/border adjustment unit 530 can be implemented in hardware or software or the combination of the two.

The output of contrast/border adjusting unit 530 is selectively fed, in certain embodiments, to a feedback control unit 540, which receives feedback from display 515, to enable real time adjustments in any of image tracking, shading, or contrast/border adjusting. The feedback control is not necessary in all embodiments.

The first video source 107 and second video source 109, in addition to the types of images discussed above, might also include one or more of motion picture video, martial arts video, video game images, etc. Various video recordings can be stored in a video library and accessed by users for various applications. The mixing unit 113 is configured to mix various video content based upon parameters, which can be preset by the user. The mixing unit 113 is also configured to mix various types of content by changing certain parameters of the video sources. For example, first video source 107 could be video of static background, and second video source could be dynamic activity of a person. The mixing unit 113 is capable of zooming the image of the person in the second video source and same it superimpose on the first video source. The mixing unit 113 is configured to mix plurality of video sources by changing certain parameters of the video sources such as resolution, contrast and dynamic range.

It would also be possible to utilize an image tracking unit 210 on both inputs from the first and second video sources 107 and 109, to enable real time composition from two or more video sources. It is possible to provide video data from third and fourth video sources, and image tracking, shading control; contrast/border adjustment can be configured as necessary.

In certain embodiments of the present invention, the second video source 109 might be a prerecorded stage or background scene, and first video source 107 can be live video providing video data from a remote location. It is also possible for second video source 109 to be stored video from the video library. Selection of an image from first video source 107 to be superimposed onto video source 109 can be done, for example, with a keyboard, mouse, or wireless remote control unit. Selection of the image can be done within selecting unit 111, either by manually or automatically highlighting a region of interest. Another embodiment is one wherein both first video source 107 and video source 109 are prerecorded and wherein regions of interest are selected within selecting unit 111 to be combined and superimposed appropriately. In another embodiment, first video source 107 and second video source 109 could be live feeds from video cameras, where certain aspects of each live feed are selected by selecting unit 111 and mixed by mixing unit 113, then output from mixing unit 113, and ultimately displayed on a display unit 115.

In one embodiment, a combined video output for a live telecast of a conversation between two users could comprise a first video source 107 containing the image of a first speaker, a second video source 109 containing an image from a second speaker, and a third video source 125 that could be a stage or studio background. The selected regions of interest from first video source 107 would be the first speaker, the selected region of interest from the second video source 109 would be the second speaker, and region selecting unit 111 would select the images of the first and second speakers, and the background from the third video source, transmit them to mixing unit 113 which would apply shading control, and contrast/border adjustment to the images, place the images in the appropriate locations in the background, and output the signal which would then be received by users or viewers, and output on a display. The intended net effect or the impression created for a viewer, therefore, would be the image of the two speakers being in the same room or the same studio, or in the same premises, having a face-to-face conversation, even though they are actually in remote locations. A fourth or fifth video source could be provided, as necessary, which could provide images of a moderator, or other scenes or persons.

In one embodiment of the invention, first video source 107 could be a video output from video camera aimed at a person or a viewer of the display unit, the second video source 109 could be, for example, a scene from a movie, and the video karaoke system makes it possible to superimpose the image of the viewer's face captured by the video camera (and tracked by the video camera) such that the combined output viewed is one where one of the characters in the scene from a movie is that of the viewer or person whose image is being captured via the video camera. Thus, it a person at home could, for amusement purposes, superimpose their image, captured as one of the video input sources, in place of a character in a movie, such as those of a action hero in a well known movie.

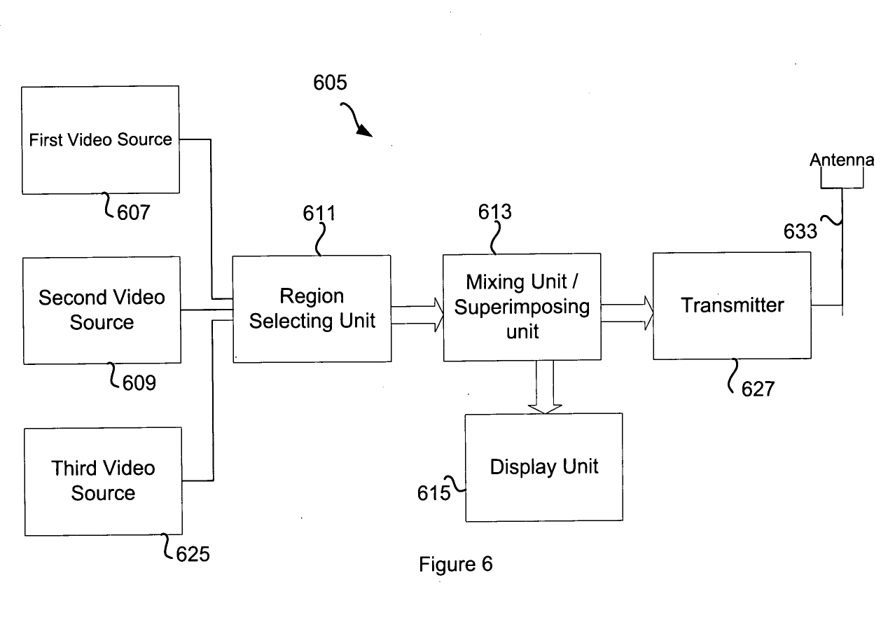

FIG. 6 is a schematic block diagram illustrating use of video karaoke system 605 for assembling and transmitting a composite video signal, such as those used created by combining video data from one or more video sources, prior to a video broadcast of the combined video data for a satellite broadcast or cable TV broadcast. A set-top-box at a user's premises is expected to receive the combined video output and display them on a television. The video karaoke system 605 comprises multiple video sources, such as a first video source 607, a second video source 609 and a third video source 625, one or more of which is combined using a mixing unit/superimposing unit 613 to create a combined output that is broadcast using a transmitter 627 and the antenna 633. A region selection unit 611 facilitates the selection of one or more regions of interest in each video source, and makes these regions of interests available for mixing or superimposing by the mixing unit/superimposing unit 613. In one embodiment, the mixing unit/superimposing unit 613 is not used to combine the regions of interest from the individual video sources, and the individual video sources, or subsets thereof, are communicated, in the same channel or using separate channels, to the transmitter 627 where it is transmitted. Thus, the transmitter transmits individual video data from each video source, or selective regions of interest from each video source, as selected or controlled by the region selecting unit 611. In a different embodiment, the regions of interest are combined into one single output before it is transmitted by the transmitter 627.

In one embodiment, a set-top-box at a user's premises is capable of not only receiving the cable TV or satellite broadcast signals for display on the television display, it is also capable of capturing a video stream (or signals) from the local second video source. It is also capable of combining video sources under the control of a user, whose input is provided via a remote control or via a keyboard. Thus, the user can control which characters in a movie being received from a satellite broadcast or a Cable TV broadcast is to be replaced by the real-time image captured from a local (second video source) camera. The set-top-box provides the functionality of the mixing unit in one embodiment. In another embodiment, the television display provides the functionality of the mixing unit.

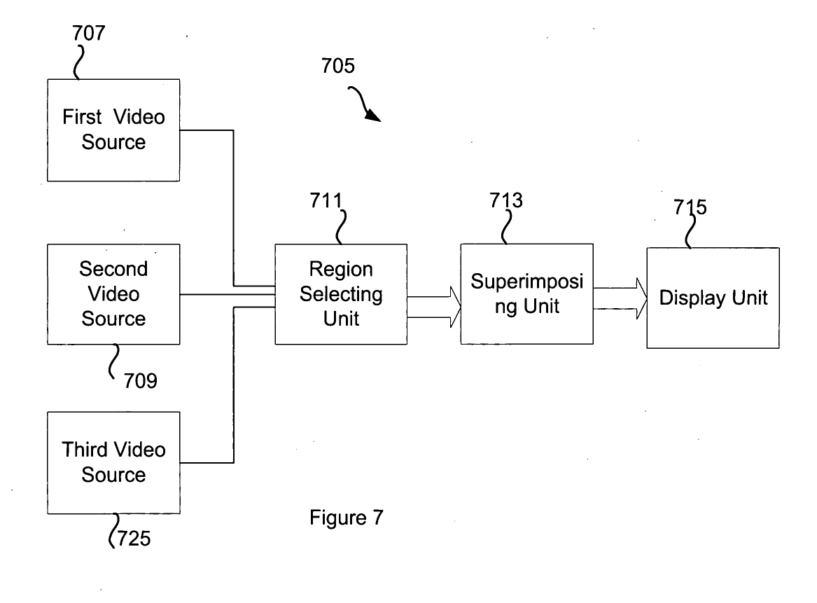

FIG. 7 is schematic block diagram of video karaoke system 705 for combining information from different video sources to get a multi-spectral, information about the scene. The video karaoke system 705 comprises a plurality of video sources, such as a first video source 707, a second video source 709 and a third video source 725, each video source providing an image of the same geographical area or same object, but in a different spectral region. Thus, by combining the multi-spectral images of the same object or geographical area, the combined image will have more details than would be possible by employing just one video source from one spectral region. For example, in satellite and remote sensing applications, multiple video cameras (considered multiple video sources) are used to acquire different type of information from the scene, as single video source cannot gives complete information about the scene served. The information from different sources is combined to get details information about the scene. For example, first video source 707 could be visual band data, which gives visual information; the second video source 709 could be thermal IR data, which gives information about temperature, the third video source 725 that gives information about metal material detection. In most cases information provided by each of single video source could be incomplete, inconsistent or imprecise. In many cases, some ambiguities will be caused when we use only one video source to perceive the real world.

In one embodiment, a multiple video data of same scene, acquired by different video cameras, each camera considered as one video source 707, 79, 725 provides complementary information about the same or similar live scene. The superimposing unit 713 (or a mixing unit 113) combines information from different video sources 707, 709, 725, to get multispectral information about the same or similar scene. The output of superimposing unit 713 is provided to a display unit 715, which displays the multispectral information about the same or similar scene, which gives different, and a more comprehensive information about the same or similar scene than would be possible from a single video source (in a single video output).

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

We claim:

1. A video karaoke system, comprising:
a first video source that provides a first video data;
a second video source that provides a second video data;
a mixing unit receiving the first video data from the first video source and the second video data from the second video source;
the mixing unit providing a combined output comprising at least a portion of the first video data and the second video data.

2. The video karaoke system according to claim 1 further comprising a display unit for displaying the output of the mixing unit.

3. The video karaoke system as recited in claim 1, wherein the mixing unit mixes the input from the first video source and the second video source in real time.

4. The video karaoke system as recited in claim 2, further comprising a region selecting unit for selecting at least one region of interest in at least one of the first video data and the second video data such that the at least one region of interest can be employed to create the combined output.

5. The video karaoke system as recited in claim 4, wherein the mixing unit further comprises an image tracking unit for tracking the at least one region of interest that is a dynamic region of interest from one of the first and second video sources.

6. The video karaoke system as recited in claim 5 further comprising:
the first video data comprising an associated first shading;
the second video data comprising an associated second shading;
the mixing unit further comprising a shading control for selectively adjusting at least one of the first shading and the second shading, such that the shading of the combined output is consistent.

7. The video karaoke system as recited in claim 6, wherein the mixing unit further comprises a contrast/border adjusting unit for adjusting a contrast and a border between selected portions of the first video data and the second video data that is combined to generate the combined output.

8. The video karaoke system as recited in claim 7, further comprising a feedback control unit for adjusting the output of the mixing unit based upon the combined output.

9. The video karaoke system as recited in claim 2, wherein at least one of the first video data and the second video data comprises a predefined video stream.

10. The video karaoke system as recited in claim 2, wherein at least one of the first video data and the second video data comprise a live video feed from an image capture device.

11. The video karaoke system as recited in claim 2, wherein one of the first and second video sources comprises a video game data, and wherein the other of the first and second video sources comprises a live data from a video feed.

12. The video karaoke system recited in claim 2, wherein the first video data comprises a live video feed from a remote location and wherein the second video data comprises video data from a local video source.

13. The video karaoke system as recited in claim 2 wherein the first video data comprises a video of dynamic activity captured locally from a local video camera in close proximity with a viewer and the second video data comprises a video game data being played by the viewer.

14. The video karaoke system as recited in claim 13 wherein said first video data comprises graphics.

15. The video karaoke system recited in claim 2 wherein said first video data comprises textual data.

16. The video karaoke system as recited in claim 2, wherein the first data is a computer generated action sequence, the second video source is a video camera tracking and capturing a viewer's movements as the viewer responds to the combined output displayed on the display unit, the second video data comprising a live video data from the video camera.

17. The video karaoke system as recited in claim 2, further comprising a display receiving input from the mixing unit, and wherein said display is configured in proximity to one of the first and second video sources, and wherein video data from the one of the first and second video sources is influenced by the combined output shown on the display unit.

18. The video karaoke system as recited in claim 2, wherein the mixing unit selects at least one first region of interest from a plurality of regions of interest from the first video data and at least one second region of interest from a plurality of regions of interest from the second video data in order to generate the combined output.

19. The video karaoke system as recited in claim 2, further comprising a selecting unit for selecting a region of interest of one of the first video data and the second video data, the selecting unit capable of being managed and manipulated by an input device that is one of a keyboard, a mouse, a remote pointing device, a tablet, and a touch screen.

20. A method for generating video karaoke, the method comprising:
receiving a first video data from a first video source;
obtaining a second video data from a second video source;
selecting a selected region of interest from one of the first video data and the second video data;
mixing the selected region of interest with the other of the one of the first video data and the second video data, thereby creating a combined video output in real time.

21. The method as recited in claim 20 wherein the step of receiving the first video data comprises capturing a dynamic video data from an image capture device;
wherein said step of obtaining the second video data comprises retrieving prerecorded video data from the second video source;
wherein said selecting comprises identifying a portion of the first video data; and
wherein mixing comprises combining the selected portion of the first video data with the second video data.

22. The method as recited in claim 21 wherein the dynamic video data that is captured by the image capture device comprises a video data tracking the movements of a viewer viewing the combined video output in real time on a display unit, that is in close visual proximity to the viewer and the image capture device.

23. The method as recited in claim 20 further comprising:
adjusting a shading of the selected video data in the selected region of interest such that the combined output is an enhanced superimposition of the selected video data and the other of the one of the first video data and the second video data.

24. The video karaoke system of claim 1, further comprising additional video sources providing additional video data which is input to the mixing unit.
